(19) United States
(12) Patent Application Publication
(10) Pub. No.: US 2026/0278498 A1
(43) Pub. Date: Sep. 17, 2026

(54) SYSTEMS AND METHODS FOR ARTIFICIAL INTELLIGENCE-BASED PLANNING

(71) Applicant: NVIDIA Corporation, Santa Clara, CA (US)

(72) Inventors: Jing LU, San Francisco, CA (US); Saif Ali KHAN, San Jose, CA (US); Alexandre Jacques Antoine FENDER, Austin, TX (US); Hugo Claude Robert LINSENMAIER, Oakland, CA (US); Anthony Christian Chavez NOGUERA, Union City, CA (US); Pritam GUNDECHA, San Jose, CA (US); Anbang XU, San Jose, CA (US); Rama Kalyani Tirumala AKKIRAJU, Cupertino, CA (US); Suhas MADDALI, San Jose, CA (US)

(21) Appl. No.: 19/080,114

(22) Filed: Mar. 14, 2025

(51) Int. Cl. G06Q 10/0631; G06F 8/30; G06F 11/362; G06Q 10/04

(52) U.S. Cl. CPC G06Q 10/06312; G06F 8/30; G06F 11/362; G06Q 10/04

(57) ABSTRACT

In various examples, systems and methods for AI-based planning are provided. A category of a user input received by a system may be determined based at least on content of the user input, and a dataset from one or more data stores that is relevant to the category of the user input and modification(s) to an allocation plan may be retrieved. The dataset retrieved from the data store(s) may be modified to generate model(s) based at least on the category of the user input and the modification(s) to the allocation plan. The model(s) may define variable(s), constraint(s), and objective(s). An updated allocation plan may be generated based at least on values for the variable(s) determined using an optimization process based at least on the model(s). A response to the user input indicative of the updated allocation plan may be output.

### BACKGROUND

Effective supply chain management is critical for businesses to ensure that products are delivered to customers in a timely and cost-effective manner. Supply chain management may involve customer allocation planning that includes allocating products (e.g., stock keeping unit (SKU) allocations) to customers based on business rule(s) as well as large amounts of demand data (e.g., week-over-week demand) and supply data (e.g., over a two-year time frame). The data varies constantly over time based on changing conditions, and allocation plans may need to be updated frequently to accommodate these changing conditions. Given the vast amount of data and the consistent changes that impact allocation plans, business planners require sophisticated tools to aid their decision-making for updating allocation plans.

### SUMMARY

Embodiments of the present disclosure relate to systems and methods for AI-based planning. Systems and methods are disclosed that may be used for, among other things, generating proposed allocation changes or planning experiments and/or conducting ad hoc planning experiments to efficiently evaluate the system-wide impact of potential decisions before implementation.

In contrast to conventional systems, the systems and methods presented in this disclosure may use an agentic AI-based techniques to generate and evaluate potential modifications to allocation plans in an efficient manner. An agentic AI planner system may receive a user input, which may be generated using a prompt constructor, and generate one or more tasks (e.g., in the form of prompts or sequence(s) of task(s)) to be performed based on content of a user input and a determined category of the user input. In some embodiments, the agentic AI planner system may retrieve specific data relevant to the request, modify the retrieved data based on the request, and generate one or more updated allocation plans that are provided to the user. The agentic AI planner system may also provide explanation of the changes made for the updated allocation plan(s) in a report or in response to prompt(s) by the user. The agentic AI planner system may generate updated allocation plans more quickly and accurately compared to current techniques as well as provide a comprehensive analysis of the updated allocation plans that are generated such that ad hoc (e.g., what-if) scenario testing may be performed in an efficient manner to evaluate the system-wide impact of potential decisions before implementation.

### BRIEF DESCRIPTION OF THE DRAWINGS

The present systems and methods for AI-based planning are described in detail below with reference to the attached drawing figures, wherein:

FIG. 1 is an illustration of a flow diagram for an example agentic AI planner system suitable for use in implementing some embodiments of the present disclosure;

FIG. 2 is an illustration of an example flow diagram for prompt construction, in accordance with some embodiments of the present disclosure;

FIG. 3 is an illustration of an example flow diagram for planning experimentation, in accordance with some embodiments of the present disclosure;

FIG. 4 is an illustration of an example flow diagram for generating proposed allocation modifications, in accordance with some embodiments of the present disclosure;

FIG. 5A is a block diagram of an example generative language model system suitable for use in implementing at least some embodiments of the present disclosure;

FIG. 5B is a block diagram of an example generative language model that includes a transformer encoder-decoder suitable for use in implementing at least some embodiments of the present disclosure;

FIG. 5C is a block diagram of an example generative language model that includes a decoder-only transformer architecture suitable for use in implementing at least some embodiments of the present disclosure;

FIG. 6 is a block diagram of an example computing device suitable for use in implementing at least some embodiments of the present disclosure; and

FIG. 7 is a block diagram of an example data center suitable for use in implementing at least some embodiments of the present disclosure.

### DETAILED DESCRIPTION

Systems and methods are disclosed related to AI-based planning. Current approaches for updating allocation plans are fairly static and time consuming and may not provide sufficient adaptability to accommodate the frequently changing conditions of a dynamic environment. For example, updating allocation plans may typically involve an operations research scientist or other Information Technology (IT) professional coding optimization model(s) based on updated information provided by business planners, and the operations research scientist may then run optimization experiments to generate proposed allocation plans based on the optimization model(s). Current techniques involve conducting the optimization experiments using the optimization model(s) in a batch manner to obtain the proposed allocation plans. This typically occurs on a daily basis as part of a scheduled production run for all products regardless of whether updates are made to the allocation plan for the products, and the production run may take hours to complete. The business planners may review the proposed allocation plans, and if further changes are needed, additional iterations of this process may be conducted to further modify the optimization model(s) and run the optimization experiments. These current approaches may not result in optimal allocation plans in a timely manner due to the length of time for generating the proposed allocation plans and the inefficiencies related to generating the optimization model(s) for the optimization experiments.

In contrast to conventional systems, such as those described above, the systems and methods presented in this disclosure may use an agentic AI planner system to provide proposed allocation changes or planning experiments, conduct ad hoc planning experiments, and/or provide insights for the results of planning experiments. The agentic AI planner system may generate one or more tasks (e.g., in the form of prompts or sequence(s) of task(s)) to be performed based on user input and a determined category of the user input. In some embodiments, the agentic AI planner system may retrieve specific data relevant to the request, modify the data based on the request, and generate one or more updated allocation plans that are provided to the user. The agentic AI planner system may also provide explanation of the changes made for the updated allocation plan(s) in a report or in response to prompt(s) by the user. The agentic AI planner system may generate updated allocation plans more quickly and accurately compared to current techniques as well as provide a comprehensive analysis of the updated allocation plans that are generated. The agentic AI planner system may be used to perform ad hoc (e.g., what-if) scenario testing in an efficient manner to evaluate the system-wide impact of potential decisions before implementation.

An agentic AI planner system as described herein may include functions to perform various tasks associated with generating proposed allocation changes or planning experiments, conducting ad hoc planning experiments to generate updated allocation plans, and/or providing insights for the results of planning experiments. The agentic AI planner system may include one or more planning functions that may determine a category of the request and generate one or more tasks for itself and/or other functions to perform. The agentic AI planner system may also include other functions that may retrieve data (e.g., from one or more data stores) that is relevant to the request, modify the retrieved data based on the request, and generate one or more updated allocation plans that are provided to the user. The agentic AI planner system may utilize one or more optimizer functions that may generate the updated allocation plans and one or more explanation functions that may generate comprehensive analysis of the updated allocation plans. The function(s) of the agentic AI planner system may be implemented using one or more machine learning models. For example, the function(s) of the agentic AI planner system may be implemented using large language model(s) (LLM(s)) or other types of generative AI applications. In some embodiments, the function(s) of the agentic AI planner system may be implemented using one or more microservices.

A user input may be provided to the agentic AI planner system via a user interface. In some embodiments, the user provides the user input (e.g., natural language prompt(s)) via a chatbot-based interface. The agentic AI planner system may require login credentials and implement other security measures to limit access to the user interface. A user may provide a variety of inputs depending on what features of the agentic AI planner system the user wants to utilize. In some embodiments, a prompt constructor may be used to aid the user in generating the user input. For example, the user interface of the agentic AI planner system may include selectable lists or fillable fields for various types of information (e.g., profile information, product information, buffer stock, customer tier, frozen horizon, allocation rules, etc.), and the prompt constructor may automatically generate a prompt having the proper structure, content, etc. that has been tested when developing the agentic AI planner system.

The planning function(s) may determine a category of the user input (e.g., indicative of the intent of the user) based on the content of the user input. In some embodiments, the planning function(s) may determine that the user input has one of a list of predefined categories that may include, but are not limited to, general greeting (e.g., salutation), erroneous request (e.g., request for changes that are not allowed), optimization problem request (e.g., modification(s) for what-if scenario experiment), suggestion request (e.g., request for proposed modifications for what-if scenario experiment(s)), explanation request (e.g., request for more explanation on a topic or output), or vague request (e.g., the request needs clarification). Based on the determined category of the user input, the planning function(s) may perform one or more operations based on the determined category and the content of the user input. The one or more operations may include generating one or more tasks for the planning function(s) and/or other function(s) of the agentic AI planner system to implement. The planning function(s) may determine which functions are to perform which tasks and whether the tasks are to be performed in sequence or in parallel. Where the user input is determined to be the category of an optimization problem, suggestion request, or explanation request, the planning function(s) may generate one or more tasks for the data retrieval function(s), the data modifier function(s), the optimizer function(s), and/or the explanation function(s) as discussed herein. Where the user input is determined to be the category of a general greeting, an erroneous request, or a vague request, the planning function(s) may provide a response to the user, for example, with a greeting, an indication of the error(s) in the request (e.g., request a change that cannot be made), or requesting clarification, respectively.

The agentic AI planner system may include retrieval function(s) that may retrieve a dataset from one or more data stores that is relevant to user input. That is, only data that is relevant to the user input is retrieved in the dataset from the data store(s). In some embodiments, the retrieval function(s) retrieve the dataset from the data store(s) based on one or more task(s) assigned to the retrieval function(s) by the planning function(s). The data store(s) (e.g., supply chain database(s)) may include data from one or more sources, and the data in the data store(s) may be updated over time (e.g., continuously ingested) and include data in different formats (e.g., CSV or spreadsheet workbooks). The data may include, but is not limited to, information related to product supply, orders, shipping, location, and forecasting.

The agentic AI planner system may include one or more data modifier functions that may generate code (e.g., Python code) to modify the data retrieved from the data store by the retrieval function(s). The data modifier function(s) may build model(s) based on the retrieved data and the content of the user input. The model(s) may include constraint(s), objective(s), and variable(s) that define the planning experiment. The data modifier function(s) may generate the code that operates directly on the retrieved data, and the code may be executed after being written. In some embodiments, a code debugger may be implemented when the code generated by the data modifier function(s) generates one or more errors when it is executed. The code debugger may receive the generated code, the error(s), and task content (e.g., task allocated by the planning function(s)) and generate revised code based on those inputs that addresses the error(s).

In some embodiments, the agentic AI planner system may include one or more preprocessors that receive the model(s) generated by the data modifier function(s) prior to the model(s) being provided to the optimizer function(s). The preprocessor(s) may analyze the data to determine whether the type of data generated by the data modifier function(s) is correct and, if not, generate new data in a format that is compatible with the optimizer function(s). For example, the preprocessor(s) may convert the data provided by the data modifier function(s) into the format that is compatible with the optimizer function(s) and then provide that compatible data to the optimizer function(s).

The optimizer function(s) may receive the modified data (updated by the preprocessor(s), if needed) and generate updated allocation plan(s) based on the modified data. The optimizer function(s) may comprise one or more optimization solvers that utilize linear programming and/or mixed-integer linear programming to solve the model(s) represented by the modified data generated by the data modifier function(s). The updated allocation plan(s) generated by the optimizer function(s) may include data indicative of optimal values of the variable(s) determined by the optimizer function(s) based on the defined constraint(s) and objective(s) in the modified data.

In some embodiments, the updated allocation plan(s) may be provided to the explanation function(s), and the explanation function(s) may analyze the updated allocation plan(s) to generate a comprehensive analysis of the updated allocation plan(s). The explanation function(s) may determine differences between the updated allocation plan(s) and the initial allocation plan(s) and generate indications of the differences. The comprehensive analysis of the updated allocation plan(s), including the indications of differences, may be generated in natural language, for example, using one or more LLMs. The analysis generated by the explanation function(s) may be provided to the planning function(s).

The planning function(s) may generate a response to the user input that is indicative of the updated allocation plan(s). For example, the response may include the updated allocation plan(s) generated by the optimizer function(s) and/or the analysis generated by the explanation function(s), if applicable. The user may provide further inputs asking follow-up questions (e.g., requesting additional explanation of the changes reflected in the updated allocation plan(s)), and the agentic AI planner system may generate responses based on the updated allocation plan(s) (e.g., using the explanation function(s)). The planning function(s) may also provide the updated allocation plan(s) generated by the optimizer function(s) and/or the analysis generated by the explanation function(s) to a dashboard. In some embodiments, the data for the updated allocation plan(s) may be visually displayed for the user (e.g., using table(s), graph(s), etc.). The agentic AI planner system may include filtering and/or sorting mechanisms that enable a user to customize the view of the data for the updated allocation plan(s). For example, the agentic AI planner system may generate code to filter and sort the data based on a user request and create a row-based function to produce an interpretation of the current row of data (e.g., using LLM(s)).

The agentic AI planner system may provide one or more validation mechanisms for a user to verify the correctness of the data for the updated allocation plan(s). For example, the agentic AI planner system may display data for the initial allocation side-by-side with the data for the updated allocation plan such that the changes made during the planning experiment are easily visible to the user. In some embodiments, logs may be generated for operations performed during execution of the one or more tasks by the function(s) of the agentic AI planner system and/or user feedback indicative of a quality of the response (e.g., updated allocation plan(s) and/or analysis) may be received from a user and used to update one or more parameters for the function(s) of the agentic AI planner system to improve performance.

Where the category of the user input is determined to be a suggestion request (e.g., for proposed modification(s) to an allocation plan), the planning function(s) may generate one or more tasks to perform simulations (e.g., Monte Carlo simulation) of candidate allocation plans with different parameters or settings and evaluate the simulated candidate allocation plans to generate one or more proposed modifications to an allocation plan. For example, the function(s) of the agentic AI planner system may perform simulations of the candidate allocation plans with different parameters or settings in parallel, generate one or more evaluation metrics for the simulated candidate allocation plans, rank the simulated candidate allocation plans based on the evaluation metric(s), and provide an indication of provide one or more proposed modifications to an allocation plan corresponding to the top ranked simulated candidate allocation plans.

In some embodiments, the one or more evaluation metrics may include one or more attention scores. The attention score(s) (e.g., for a particular product in a particular allocation plan) may be determined based on a time-discounted supply-demand gap or a time-discounted allocation-demand gap. The attention score(s) may be indicative of a late fulfillment at some point in the future and larger attention score(s) may be indicative of later fulfillments, so the simulated candidate allocation plans may be ranked inversely to the attention score(s).

In some embodiments, report(s) (e.g., daily report(s)) may be generated based on current allocation plans and/or the supply and demand data from data store(s) to highlight products, customers, and/or allocations that may be high priority (e.g., needing attention). The high-priority items may be identified, at least in part, based on attention score(s) as discussed above. The report(s) may also include week-over-week key figures related to supply and/or demand data.

The techniques described herein may be used to significantly increase the efficiency for conducting what-if scenario experiments compared to current approaches. For example, ad hoc planning experiments may be conducted within minutes rather than hours using previous approaches. Further, the agentic AI planner system may be used to generate proposed modifications to allocation plans by performing simulations in parallel, which may significantly reduce the time required to generate improved or optimal allocation plans.

Embodiments presented in the disclosure primarily refer to conducting what-if scenario experiments and generating updates and/or suggestions for allocation plans. However, it should be understood that techniques similar to those described herein may be used for other types of planning, forecasting, or other types of tasks. Further, while particular function(s) are described as being used to perform specific tasks to generate the responses to the user inputs, it should be understood that other combinations of functions (e.g., including more functions or fewer functions) may be utilized to implement the agentic AI planner system.

Although examples may be described herein with respect to using machine learning models, such as neural networks or diffusion models, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), small language models (SLMs), vision language models (VLMs), multi-modal language models (MMLMs), large action models (LAMs), etc.), and/or other types of machine learning models.

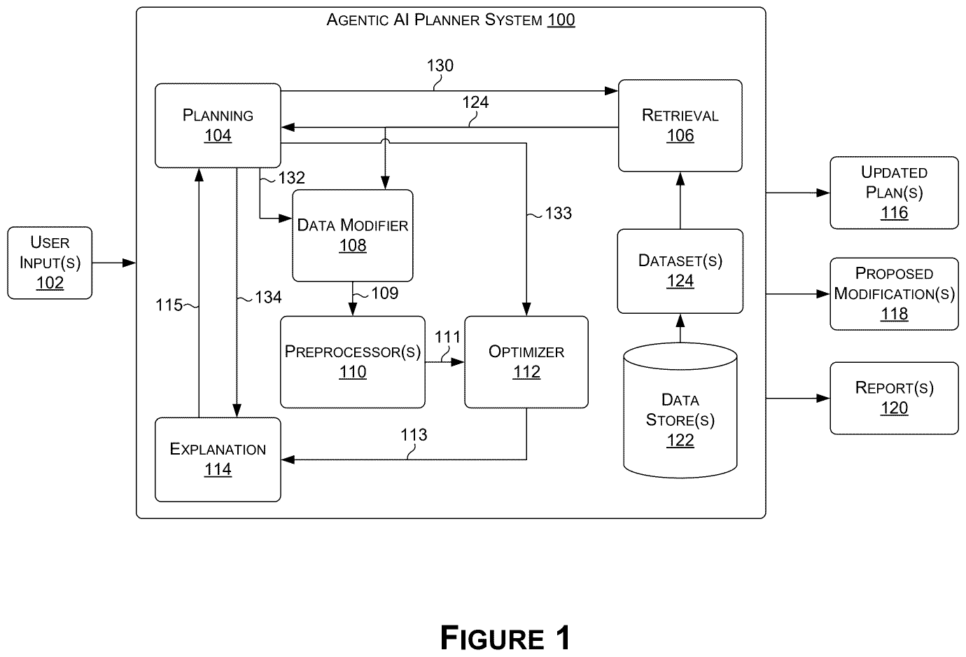

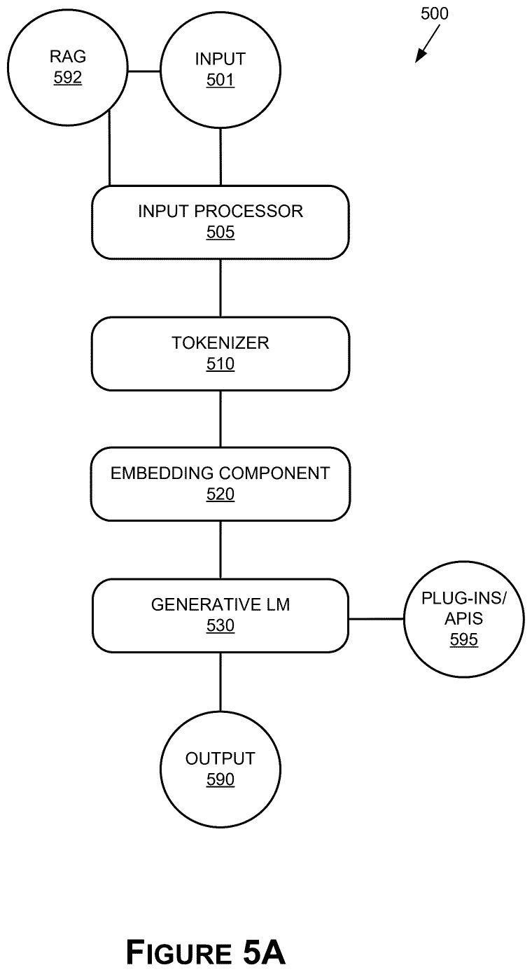

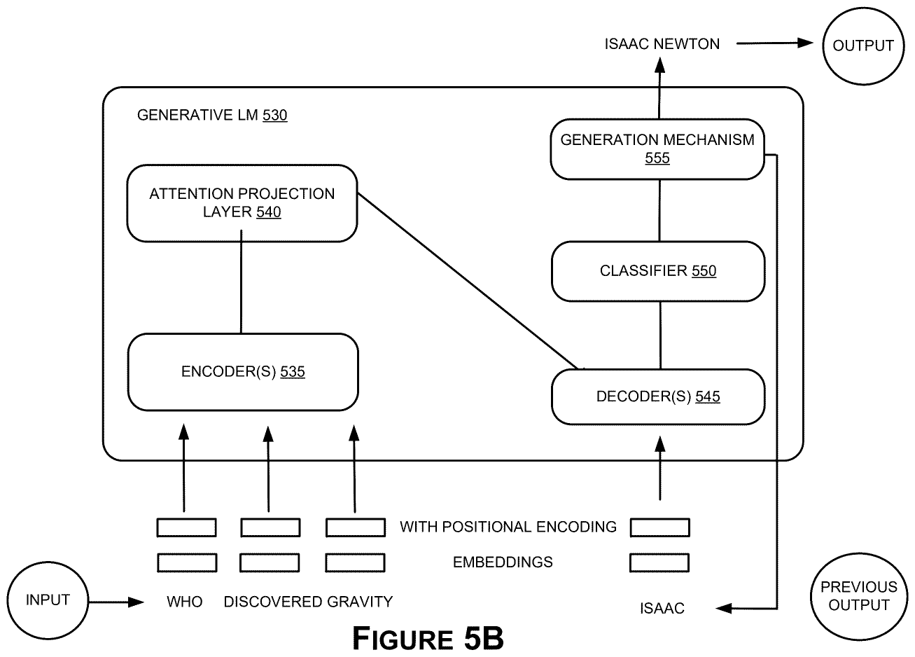

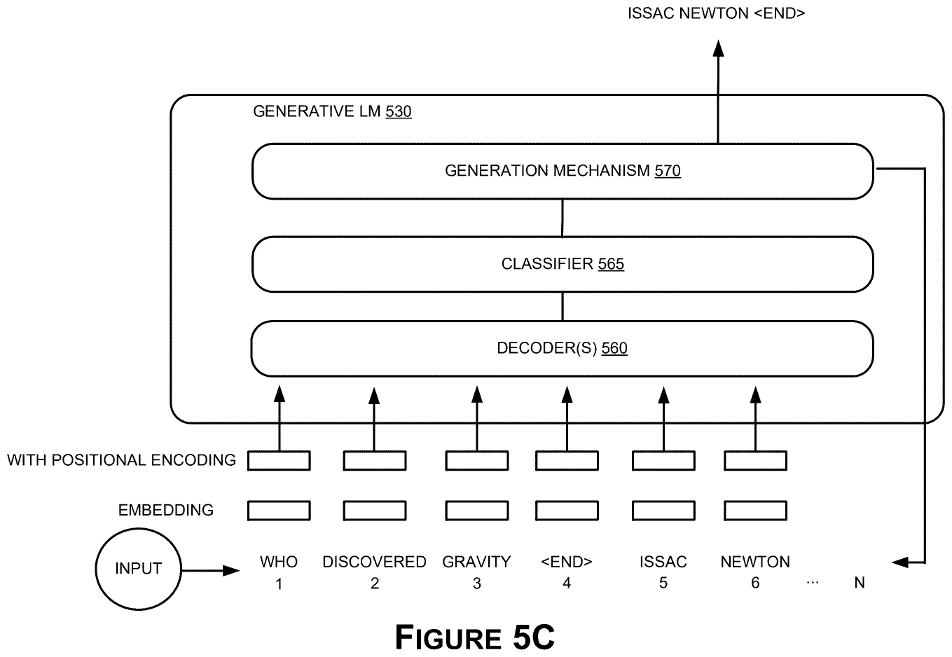

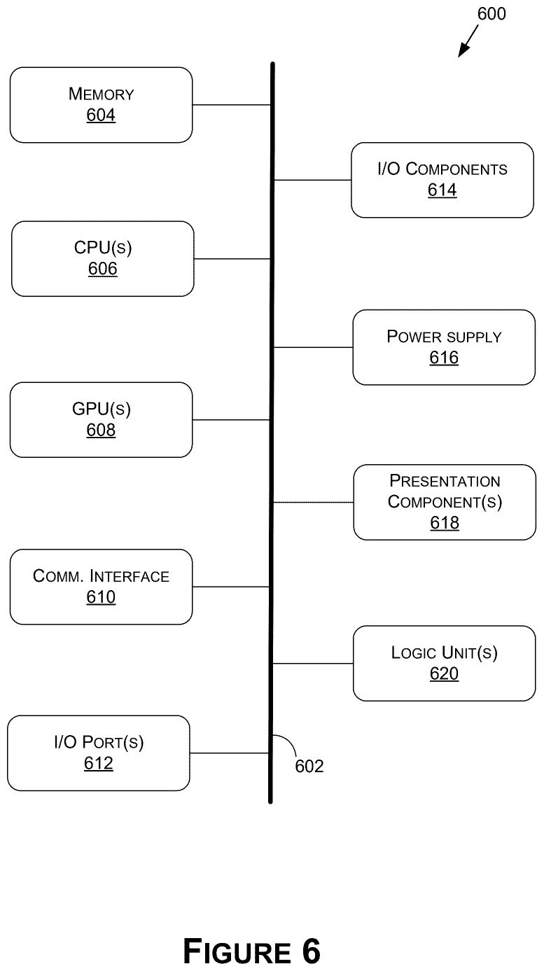

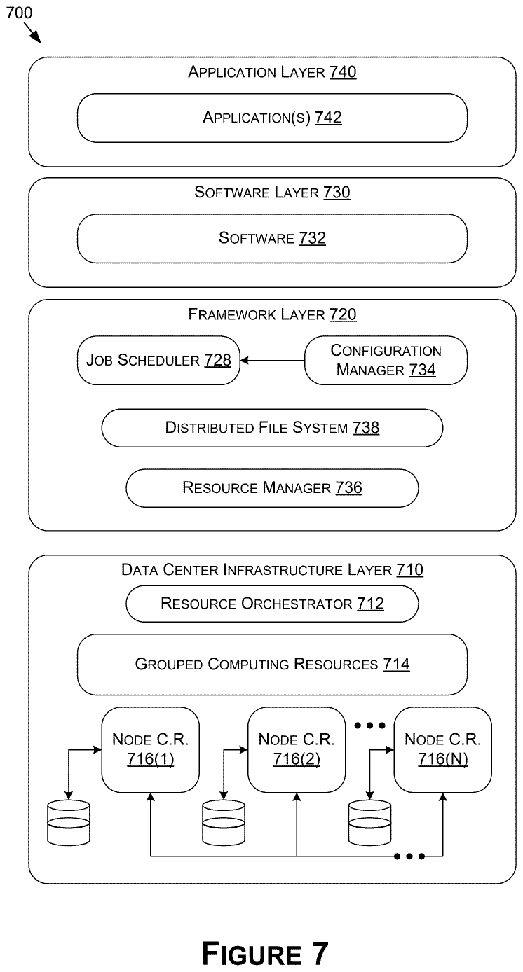

With reference to FIG. 1, FIG. 1 is an example data flow diagram illustrating the interconnection of components and flow of information of data for an agentic AI planner system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. For example, in some embodiments, the system and methods described herein may be implemented using one or more generative language models (e.g., as described in FIGS. 5A-5C), one or more computing devices or components thereof (e.g., as described in FIG. 6), and/or one or more data centers or components thereof (e.g., as described in FIG. 7).

In the example shown in FIG. 1, the agentic AI planner system 100 may include planning function(s) 104, retrieval function(s) 106, data modifier function(s) 108, preprocessor(s) 110, optimizer function(s) 112, and explanation function(s) 114. The function(s) of the agentic AI planner system 100 may be implemented as agents that utilize one or more machine learning models. For example, the function(s) of the agentic AI planner system may be implemented using language model(s) (e.g., LLM(s)) or other types of generative AI applications. In some embodiments, the function(s) of the agentic AI planner system may be implemented using one or more microservices.

The agentic AI planner system 100 may receive user input(s) 102 that are provided by a user of the agentic AI planner system 100. For example, a user may provide the user input(s) 102 via a user interface (e.g., a web user interface) for the agentic AI planner system 100. The user input(s) 102 may comprise natural language prompt(s) provided via a chatbot-based interface. The agentic AI planner system 100 may request login credentials and implement other security measures to limit access to the agentic AI planner system 100. The user input(s) 102 may include a variety of inputs depending on the features and functionality of the agentic AI planner system 100 that the user wants to utilize.

The planning function(s) 104 of the agentic AI planner system 100 may receive the user input(s) 102. The planning function(s) 104 may determine a category of the user input(s) 102, which may correspond to a predicted intent of the user for the user input(s) 102. The planning function(s) 104 may determine that the category of the user input(s) 102 by selecting one of a list of predefined categories that the user input(s) 102 may fall under. The predefined categories may include, but are not limited to, general greeting (e.g., salutation), erroneous request (e.g., request for changes that are not allowed), optimization problem request (e.g., modification(s) for what-if scenario experiment), suggestion request (e.g., request for proposed modifications for what-if scenario experiment(s)), explanation request (e.g., request for more explanation on a topic or output), or vague request (e.g., the request needs clarification). The planning function(s) 104 may perform one or more operations based on the determined category of the user input(s) 102 and the content of the user input(s) 102.

For the user input(s) 102 determined to have a category of general greeting, erroneous request, or vague request, the planning function(s) 104 may generate a response to the user input(s) 102 without generating and assigning tasks to other functions of the agentic AI planner system 100. The planning function(s) 104 may generate and output an appropriate response to the user input(s) 102 based on the content of the user input(s) 102. Where the user input(s) 102 are determined to have a category of general greeting, the planning function(s) 104 may generate and output an appropriate response to the greeting based on the content of the user input(s) 102 (e.g., using LLM(s)). Where the user input(s) 102 determined to have a category of erroneous request, the planning function(s) 104 may generate and output an appropriate response that identifies the error(s) in the user input(s) 102. For example, the planning function(s) 104 may generate a response indicating that the request in the user input(s) 102 may not be performed and provide one or more reasons (e.g., type of change being requested violates one or more rules, etc.). Where the user input(s) 102 determined to have a category of vague request, the planning function(s) 104 may generate and output a response requesting clarification of the user input(s) 102. For example, the planning function(s) 104 may generate a response indicating that the request in the user input(s) 102 may not be performed and requesting further information for the vague portions of the request.

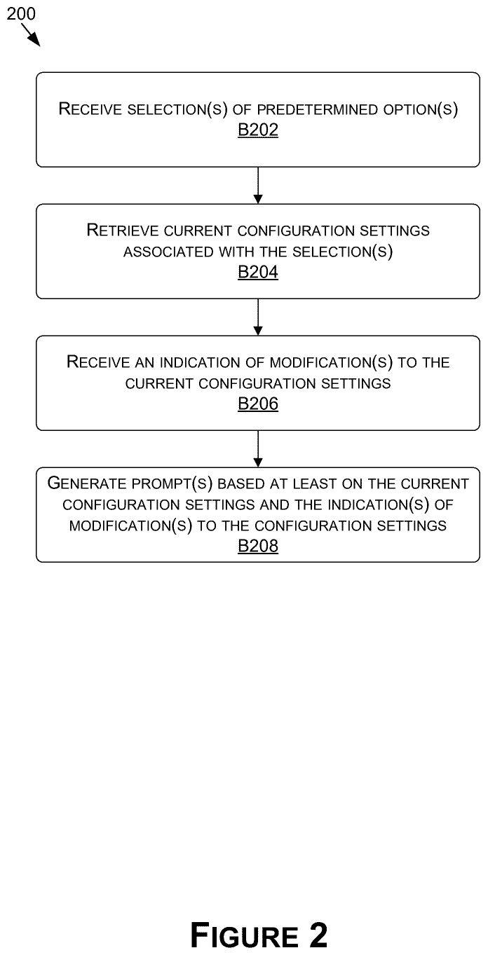

In some embodiments, a prompt constructor may be used to aid the user in generating the user input(s) 102, which may help avoid erroneous requests and/or vague requests in the user input(s) 102. For example, the user interface of the agentic AI planner system 100 may include selectable lists and/or fillable fields for various types of information (e.g., profile information, product information, buffer stock, customer tier, frozen horizon, allocation rules, etc.), and the prompt constructor may automatically generate a prompt having the proper structure, content, etc. that has been tested when developing the agentic AI planner system 100. Further details regarding prompt construction for the user input(s) 102 of the agentic AI planner system 100 are discussed herein with respect to FIG. 2.

For the user input(s) 102 determined to have a category of optimization problem, suggestion request, or explanation request, the planning function(s) 104 may generate one or more tasks for the retrieval function(s) 106, the data modifier function(s) 108, the optimizer function(s) 112, and/or the explanation function(s) 114 depending on the category and the content of the user input(s) 102. Where the user input(s) 102 are determined to have a category of explanation request, the planning function(s) 104 may generate one or more tasks for the explanation function(s) 114 (e.g., without generating one or more tasks for the other functions of the agentic AI planner system 100) depending on the content of the user input(s) 102. Where the user input(s) 102 are determined to have a category of optimization problem or suggestion request, the planning function(s) 104 may generate one or more tasks for each of the types of functions of the agentic AI planner system 100 based on the content of the user input(s) 102.

The retrieval function(s) 106 of the agentic AI planner system 100 may be assigned task(s) 130 by the planning function(s) 104, and the retrieval function(s) 106 may execute the task(s) 130 in sequence or in parallel depending on the circumstances. The task(s) 130 for the retrieval function(s) 106 may include retrieving dataset(s) 124 from data store(s) 122. The data store(s) 122 may include supply data, demand data, and other types of supply chain data, and the data may be stored in one or more formats (e.g., CSV or spreadsheet workbooks). In some embodiments, the data store(s) 122 may store data from one or more sources and may be updated over time (e.g., continuously ingest new data) as the supply chain data changes. The retrieval function(s) 106 may retrieve dataset(s) 124 relevant to the user input(s) 102, which may include retrieving only data that is related to the user input(s) 102. For example, where the user input(s) 102 relate to a particular product, the retrieval function(s) 106 may retrieve dataset(s) 124 (e.g., supply data and demand data) related to that particular product without retrieving data that is not related to that particular product. The retrieval function(s) 106 may provide the dataset(s) 124 retrieved from the data store(s) 122 to the planning function(s) 104 and/or the data modifier function(s) 108 (e.g., depending on the task(s) 130 provided by the planning function(s) 104).

In some embodiments, the retrieval function(s) 106 may provide the dataset(s) 124 to the planning function(s) 104, and the planning function(s) 104 may relay the dataset(s) 124 retrieved by the retrieval function(s) 106 from the data store(s) 122 to the data modifier function(s) 108. Alternatively, the retrieval function(s) 106 may provide the dataset(s) 124 retrieved from the data store(s) 122 directly to the data modifier function(s) 108 in addition to, or instead of, providing the dataset(s) 124 to the planning function(s) 104.

The data modifier function(s) 108 may be assigned task(s) 132 by the planning function(s) 104, and the data modifier function(s) 108 may execute the task(s) 132 in sequence or in parallel depending on the circumstances. The task(s) 132 for the data modifier function(s) 108 may include generating code to modify the dataset(s) 124 retrieved from the data store(s) 122 by the retrieval function(s) 106. For example, the data modifier function(s) 108 may generate code to build one or more models based on the dataset(s) 124 retrieved from the data store(s) 122 and the content of the user input(s) 102, and the model(s) may include constraint(s), objective(s), and variable(s) (e.g., that define a planning experiment). The data modifier function(s) 108 may generate code that operates directly on the dataset(s) 124, and the code may be executed after being generated (e.g., in place). In some embodiments, the agentic AI planner system 100 may implement a code debugger when the code generated by the data modifier function(s) 108 generates one or more errors when it is executed. The code debugger may receive the generated code, the error(s), and the content of the task(s) 132 and generate revised code that addresses the error(s) based on those inputs. The data modifier function(s) 108 may generate modified data 109 and output the modified data 109 to other functions (e.g., the preprocessor(s) 110 or the optimizer function(s) 112) of the agentic AI planner system 100 for further processing.

In the example shown in FIG. 1, the preprocessor(s) 110 of the agentic AI planner system 100 may receive the modified data 109 generated by the data modifier function(s) 108 prior to the modified data 109 being provided to the optimizer function(s) 112. The preprocessor(s) 110 may analyze the data in the modified data 109 to determine whether the type of data generated by the data modifier function(s) 108 is correct and, if not, generate new data (e.g., in a different format) that is compatible with the optimizer function(s) 112. For example, the preprocessor(s) 110 may convert the data provided by the data modifier function(s) 108 into a form that is compatible with the optimizer function(s) 112 and then provide this modified data 111 that is compatible with the optimizer function(s) 112. Where the modified data 109 output by the data modifier function(s) 108 is determined to be compatible with the optimizer function(s) 112, the modified data 111 provided by the preprocessor(s) 110 to the optimizer function(s) 112 may correspond to the modified data 109.

The optimizer function(s) 112 of the agentic AI planner system 100 may receive the modified data 111 from the preprocessor(s) 110. The optimizer function(s) 112 may be assigned task(s) 133 by the planning function(s) 104, and the optimizer function(s) 112 may execute the task(s) 133 in sequence or in parallel depending on the circumstances. The optimizer function(s) 112 may generate solution output(s) 113 based on the modified data 111. The optimizer function(s) 112 may comprise one or more optimization solvers (e.g., NVIDIA's cuOpt and/or Gurobi) that utilize linear programming and/or mixed-integer linear programming to generate the solution output(s) 113 based on the modified data 111. For example, where the modified data 111 includes model(s), the optimizer function(s) 112 may solve the model(s) (e.g., using linear programming and/or mixed-integer programming) and generate the solution output(s) 113 that may include data indicative of optimal values of the variable(s) determined by the optimizer function(s) 112 based on the defined constraint(s) and objective(s) in the modified data 111. The solution output(s) 113 may include data corresponding to updated plans (e.g., updated allocation plans) and/or proposed modifications (e.g., to allocation plans) depending on the type of request in the user input(s) 102.

In the example shown in FIG. 1, the optimizer function(s) 112 may provide the solution output(s) 113 to the explanation function(s) 114. The explanation function(s) 114 may be assigned task(s) 134 by the planning function(s) 104, and the explanation function(s) 114 may execute the task(s) 134 in sequence or in parallel depending on the circumstances. The task(s) 134 for the explanation function(s) 114 may include analyzing the solution output(s) 113 received from the optimizer function(s) 112 and generating analysis 115 of the solution output(s) 113 in natural language (e.g., using LLM(s)). For example, the analysis 115 may include a summary of the solution output(s) 113, identify key points of the solution output(s) 113, or other analysis tasks. The explanation function(s) 114 may also be provided additional information to provide context for the solution output(s) 113 from the optimizer function(s) 112, and the explanation function(s) 114 may also use this additional information when generating the analysis 115 of the solution output(s) 113. For example, the explanation function(s) 114 may be provided the user input(s) 102, data from the user input(s) 102, the dataset(s) 124, or other additional information that may aid the explanation function(s) 114 in describing the solution output(s) 113 in a manner that helps improve the understanding for the user of the agentic AI planner system 100. The explanation function(s) 114 may provide the solution output(s) 113 and the analysis 115 to the planning function(s) 104.

The agentic AI planner system 100 may output updated plan(s) 116, proposed modification(s) 118, and/or report(s) 120 based on the solution output(s) 113 generated by the optimizer function(s) 112 and the analysis 115 generated by the explanation function(s) 114. For example, the planning function(s) 104 may generate a response to the user input(s) 102 that includes the analysis 115. The agentic AI planner system 100 may output the updated plan(s) 116, the proposed modification(s) 118, and/or report(s) 120 based on the solution output(s) 113 and the analysis 115. For example, the agentic AI planner system 100 may generate and output the report(s) 120 that include analysis of the updated plan(s) 116 and/or the proposed modification(s) 118 generated by the explanation function(s) 114 and display data corresponding to the updated plan(s) 116 and/or the proposed modification(s) 118 (e.g., via the user interface for the agentic AI planner system 100).

Now referring to FIG. 2, FIG. 2 is a flow diagram showing a method 200 for prompt construction, in accordance with some embodiments of the present disclosure. Each block of method 200, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 200 is described, by way of example, with respect to the system of FIG. 1. However, this method may additionally or alternatively be executed by any one system, or any combination of systems, including, but not limited to, those described herein.

The method 200, at block B202, includes receiving one or more selections of one or more predetermined options. A user interface for a prompt constructor of the agentic AI planner system 100 may include one or more selectable lists for various types of information, and the user may provide the selection(s) of the predetermined option(s) via the user interface. A user may provide the selection(s) by selecting the predetermined option(s), for example, from a drop-down menu, buttons, etc. In some embodiments, a user may provide the selection(s) of the predetermined option(s) using a combination of fillable field(s) (e.g., search or filter field) and selectable lists. For example, the user may provide part of the option (e.g., first letters/numbers of a product ID, customer ID, etc.) in the fillable field that is used to filter the selectable list of options, and then the user may select the appropriate option from the filtered list of options. The predetermined option(s) may represent profile information, product information, etc.

The method 200, at block B204, includes retrieving current configuration settings for an allocation plan associated with the selection(s). A prompt constructor for the agentic AI planner system 100 may retrieve current configuration settings for the allocation plan based on the selection(s), which may include, for example, a product ID, customer ID, and/or other information. The current configuration settings for the allocation plan may be retrieved from the data store(s) 122 or from one or more different data store(s) depending on the implementation. The current configuration settings for the allocation plan may include, but are not limited to, the settings for buffer stock, customer tier(s), freeze horizon, allocation rule(s), or other configuration settings.

The method 200, at block B206, includes receiving an indication of one or more modifications to the current configuration settings for the allocation plan. The user interface of the agentic AI planner system 100 may include one or more mechanisms for providing an indication of the modifications to the current configuration settings. For example, the user interface may include one or more selectable lists, steppers, sliders, switches, fillable fields, and/or other mechanisms that a user may use to indicate desired modifications to the current configuration settings (e.g., buffer stock, customer tier, frozen horizon, allocation rules, etc.) for a planning experiment.

The method 200, at block B208, includes generating a prompt based at least on the current configuration settings for the allocation plan and the indication of modification(s) to the current configuration settings for the allocation plan. The prompt may be generated in a manner such that the prompt has the proper structure, content, etc. based on testing completed during development of the agentic AI planner system 100. For example, the prompts for an optimization problem request generated using the prompt constructor of the agentic AI planner system 100 may include the same basic structure and vary only in the particular details for a specific product, customer, etc. selected at block B202 and the modification(s) indicated at block B206. The prompts may be generated using one or more machine learning models (e.g., LLMs) or other generative models based on the current configuration settings for the allocation plan and the indication of modification(s) to the current configuration settings for the allocation plan. A user may confirm the information in the prompts generated using the prompt constructor and output the prompts as the user input(s) 102 to the agentic AI planner system 100.

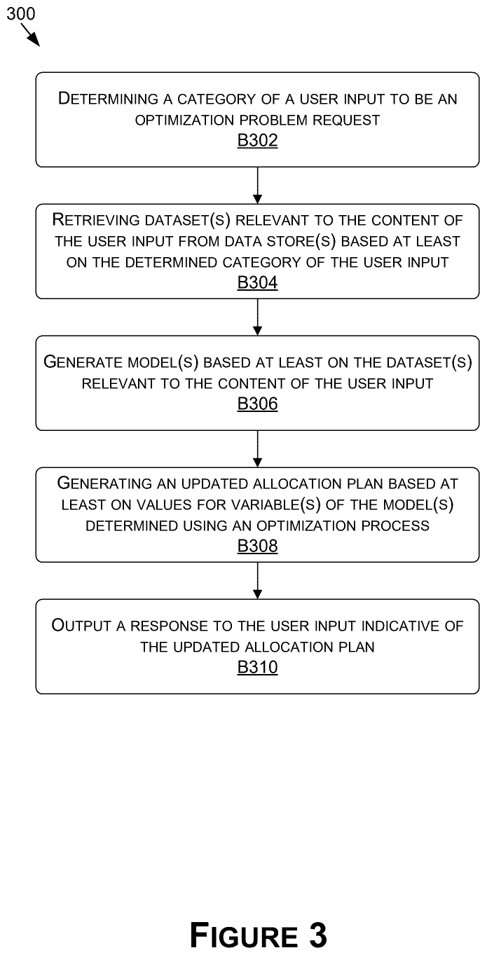

Now referring to FIG. 3, FIG. 3 is a flow diagram showing a method 300 for planning experimentation, in accordance with some embodiments of the present disclosure. Each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

The method 300, at block B302, includes determining a category of a user input to be an optimization problem request. The planning function(s) 104 may determine that the category of the user input based on a list of predefined categories that the user input may fall under based on the content of the user input. The predefined categories may include, but are not limited to, general greeting (e.g., salutation), erroneous request (e.g., request for changes that are not allowed), optimization problem request (e.g., modification(s) for what-if scenario experiment), suggestion request (e.g., request for proposed modifications for what-if scenario experiment(s)), explanation request (e.g., request for more explanation on a topic or output), or vague request (e.g., the request needs clarification). The category of the user input may be determined using natural language processing techniques. For example, the planning function(s) 104 may process the user input using natural language processing techniques and determine that the category is an optimization problem request based on whether the user input references a product, customer, modification to an allocation plan, and/or other content that may be included in the user input that is indicative of the user input being directed to an optimization problem request. As discussed above with respect to FIGS. 1-2, in some embodiments, a prompt constructor may be used to aid the user in generating the user input. For example, the user interface of the agentic AI planner system 100 may include selectable lists or fillable fields for various types of information (e.g., profile information, product information, buffer stock, customer tier, frozen horizon, allocation rules, etc.). In some embodiments, the prompt constructor may automatically generate a prompt with a category indicator indicative of an optimization problem request.

The method 300, at block B304, includes retrieving one or more datasets relevant to the content of the user input from one or more data stores based at least on the determined category of the user input being an optimization problem request. The planning function(s) 104 may assign task(s) 130 for the retrieval function(s) 106 to retrieve dataset(s) 124 (e.g., supply chain data) from the data store(s) 122 (e.g., supply chain database(s)) relevant to the content of the user input. For example, the planning function(s) 104 may assign task(s) 130 for the retrieval function(s) 106 to retrieve supply chain data (e.g., supply data and/or demand data) only for a particular product, customer, allocation plan, etc. referenced in the user input. The retrieval function(s) 106 may provide the dataset(s) 124 to the planning function(s) 104 and/or the data modifier function(s) 108 depending on the task(s) 130.

The method 300, at block B306, includes generating one or more models based on the dataset(s) relevant to the content of the user input. The dataset(s) 124 retrieved by the retrieval function(s) 106 may be provided to the data modifier function(s) 108 either directly or via the planning function(s) 104. The planning function(s) 104 may assign task(s) 132 to the data modifier function(s) 108 for the data modifier function(s) 108 to generate the model(s) by modifying the dataset(s) 124 retrieved from the data store(s) 122. The data modifier function(s) 108 may generate code (e.g., Python code) that operates directly on the dataset(s) 124 retrieved from the data store(s) 122 and generates the model(s) from the dataset(s) 124. The data modifier function(s) 108 may execute the code upon generation. Where one or more errors are triggered upon execution of the code generated by the data modifier function(s) 108, a code debugger may be used to generate revised code based on generated code, the triggered error(s), and the content of the task(s) 132 provided by the planning function(s) 104 to the data modifier function(s) 108. The debugging process may be repeated until no errors are triggered when executing the revised code.

The model(s) generated by the data modifier function(s) 108 may define variable(s), constraint(s), and objective(s) for the planning experiment. The variable(s) for the model(s) may represent parameters of the system. For example, the variable(s) may represent customer allocation(s), supply, demand, or other parameters for the model(s) that are included (e.g., based on the user input(s) 102). The constraint(s) for the model(s) may represent constraints for the system. For example, the constraint(s) may represent boundaries (e.g., minimum or maximum values) for variable(s) of the model(s). The objective(s) may be defined as a function that is to be optimized (e.g., minimized or maximized) using the optimizer function(s) 112. The data modifier function(s) 108 may also generate time limits or other configuration parameters for the optimizer function(s) 112 when generating solution output(s) 113 based on the model(s).

In some embodiments, the model(s) generated by the data modifier function(s) 108 may be provided to preprocessor(s) 110, and the preprocessor(s) 110 may determine whether the model(s) are compatible with the optimizer function(s) 112 that are to solve for the variable(s) of the model(s) based on the constraint(s) and objective(s) defined. The preprocessor(s) 110 may convert the model(s) generated by the data modifier function(s) 108 to a form that is compatible with the programming techniques utilized by the optimizer function(s) 112. After converting the model(s) to a form that is compatible with the optimizer function(s) 112 and/or verifying that the model(s) have a form that is compatible with the optimizer function(s) 112, the preprocessor(s) 110 may output the model(s) for solving.

The method 300, at block B308, includes generating one or more updated allocation plans based on values for one or more variables determined using an optimization process based on the model(s). The optimizer function(s) 112 may receive the model(s) from the data modifier function(s) 108 (or the preprocessor(s) 110, if applicable) and generate updated allocation plan(s) from the model(s) for the planning experiment as the solution output(s) 113. The optimizer function(s) 112 may be implemented using one or more optimization solvers (e.g., NVIDIA's cuOpt, Gurobi, etc.) that implement linear programming and/or mixed-integer linear programming to solve the model(s) for the planning experiment, which may include generating values for the variable(s) of the model(s) based on the constraint(s) and objective(s) defined by the model(s) for the planning experiment. The updated allocation plan(s) may be represented by the variable(s) for the model(s) determined using the optimizer function(s) 112.

The method 300, at block B310, includes outputting a response to the user input(s) indicative of the updated allocation plan(s). The updated allocation plan(s) determined by the optimizer function(s) 112 may be provided to the explanation function(s) 114. The planning function(s) 104 may assign task(s) 134 for the explanation function(s) 114 to analyze the updated allocation plan(s) and generate an analysis 115, which may include a summary, outline, key points, etc. In some embodiments, the explanation function(s) 114 may receive an initial allocation plan, which is being modified in the planning experiment, from the planning function(s) 104 or another component of the agentic AI planner system 100. The explanation function(s) 114 may compare the initial allocation plan to the updated allocation plan(s) generated by the optimizer function(s) 112 to determine the differences between the initial allocation plan and the updated allocation plan(s). The analysis, including the indications of the differences, may be generated in natural language (e.g., using LLM(s) for the analysis 115. The explanation function(s) 114 may provide the analysis 115 to the planning function(s) 104 to be output as the response to the user input. In some embodiments, the response may include a visual representation of the updated allocation plan(s), which provides actionable data such as product availability, shipping schedules, inventory levels, and fulfillment status, enabling the user to make informed decisions based on the updated plan.

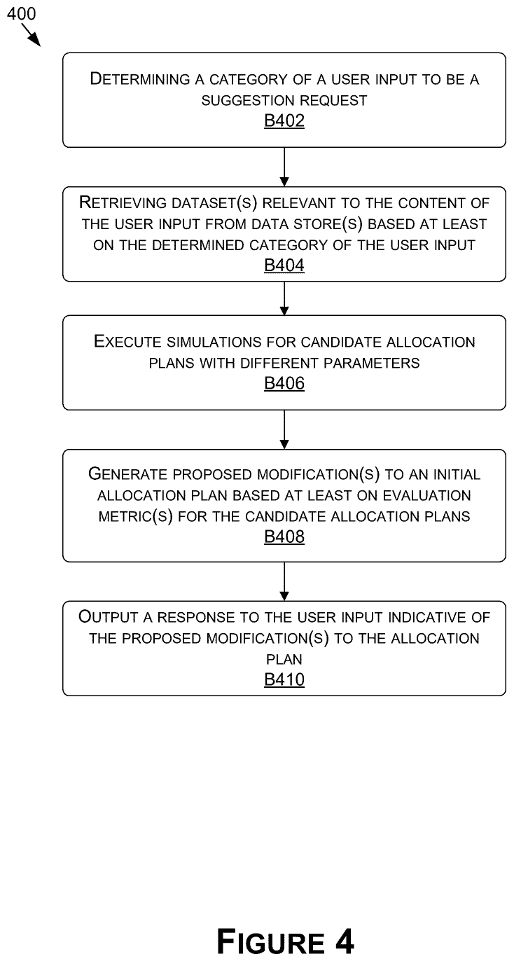

Now referring to FIG. 4, FIG. 4 is a flow diagram showing a method 400 for generating proposed allocation modifications, in accordance with some embodiments of the present disclosure. Each block of method 400, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 400 is described, by way of example, with respect to the system of FIG. 1. However, this method may additionally or alternatively be executed by any one system, or any combination of systems, including, but not limited to, those described herein.

The method 400, at blocks B402 includes determining a category of a user input to be a suggestion request. The planning function(s) 104 may determine that the category of the user input based on a list of predefined categories that the user input may fall under based on the content of the user input. The predefined categories may include, but are not limited to, general greeting (e.g., salutation), erroneous request (e.g., request for changes that are not allowed), optimization problem request (e.g., modification(s) for what-if scenario experiment), suggestion request (e.g., request for proposed modifications for what-if scenario experiment(s)), explanation request (e.g., request for more explanation on a topic or output), or vague request (e.g., the request needs clarification). The category of the user input may be determined using natural language processing techniques. For example, the planning function(s) 104 may process the user input using natural language processing techniques and determine that the category is a suggestion request based on whether the user input references a product, customer, and/or other content that may be included in the user input that is indicative of the user input being directed to a suggestion request. As discussed above with respect to FIGS. 1-2, in some embodiments, a prompt constructor may be used to aid the user in generating the user input. For example, the user interface of the agentic AI planner system 100 may include selectable lists or fillable fields for various types of information (e.g., profile information, product information, buffer stock, customer tier, frozen horizon, allocation rules, etc.). In some embodiments, the prompt constructor may automatically generate a prompt with a category indicator indicative of a suggestion request.

The method 400, at block B404, includes retrieving one or more datasets relevant to the content of the user input from one or more data stores based at least on the determined category of the user input being a suggestion request. The planning function(s) 104 may assign task(s) 130 for the retrieval function(s) 106 to retrieve dataset(s) 124 (e.g., supply chain data) from the data store(s) 122 (e.g., supply chain database(s)) relevant to the content of the user input. For example, the planning function(s) 104 may assign task(s) 130 for the retrieval function(s) 106 to retrieve supply chain data (e.g., supply data and/or demand data) only for a particular product, customer, etc. referenced in the user input. The retrieval function(s) 106 may provide the dataset(s) 124 to the planning function(s) 104 and/or the data modifier function(s) 108 depending on the task(s) 130.

The method 400, at block B406, includes executing simulations for candidate allocation plans with different parameters. The planning function(s) 104 may assign task(s) 130 to the data modifier function(s) 108 and the optimizer function(s) 112 to perform simulations to explore a parameter space for different settings for modifying the initial allocation plan based on the dataset(s) 124 retrieved from the data store(s) 122. The simulations may include searching within a defined parameter space (e.g., boundaries for the various parameters for the allocation plan) and optimizing (e.g., minimizing or maximizing) a particular function or score. The simulations may be implemented using Monte Carlo simulations or another type of simulation. In some embodiments, the data modifier function(s) 108 may generate code to modify the dataset(s) 124 retrieved from the data store(s) 122 in a manner that defines the parameter space(s) to be search, probability distribution(s), number of simulations, model(s), function(s), output(s), and/or other parameters for executing the simulations. The optimizer function(s) 112 may receive the modified data from the data modifier function(s) 108 (or preprocessor(s) 110, if applicable) and generate the candidate allocation plans with different parameters. In some embodiments, the simulations may be executed in parallel by the optimizer function(s) 112 such that the candidate allocation plans with different parameters are generated in parallel.

In some embodiments, the planning function(s) 104 may assign task(s) to the data modifier function(s) 108 and optimizer function(s) 112 such that evaluation metric(s) are generated for the candidate allocation plans generated by the optimizer function(s) 112. The evaluation metric(s) may include one or more attention scores. The attention score(s) (e.g., for a particular product in a particular allocation plan) may be determined based on a time-discounted supply-demand gap or a time-discounted allocation-demand gap. In one example, the attention score(s) for the products may be represented using the following formula:

$${Attention\_Score}_{i} = {\sum }_{t = 1}^{T} ( {Gap}_{i , t} \cdot \frac{1}{{( 1 + r )}^{{TimeDiff}_{i , t}}} )$$

where r is the discounted rate, Gap_{i,t} is the gap (e.g., demand-supply gap or the demand-allocation gap depending on implementation) for the ith product at a particular time, and TimeDiff_{i,t} is a difference between the particular time and the current time.

The method 400, at block B408, includes generating one or more proposed modifications to the initial allocation plan based at least on evaluation metric(s) for the candidate allocation plans. The planning function(s) 104 may assign task(s) to the optimizer function(s) 112 and/or the explanation function(s) 114 to rank the candidate allocation plans simulated by the optimizer function(s) 112 based on the evaluation metric(s). The attention score(s) discussed above may be one of the evaluation metric(s) and used to rank the candidate allocation plans. For example, the attention score(s) may be indicative of a late fulfillment at some point in the future and larger attention score(s) may be indicative of later fulfillments, so the simulated candidate allocation plans may be ranked inversely to the attention score(s). Where the optimizer function(s) 112 may rank the candidate allocation plans, the optimizer function(s) 112 may output a subset of the candidate allocation plans (e.g., as configured for the simulations) having the best evaluation metric(s) (e.g., lowest attention scores).

The candidate allocation plans determined by the optimizer function(s) 112 and the initial allocation plan that forms the basis for the simulations may be provided to the explanation function(s) 114. The planning function(s) 104 may assign task(s) for the explanation function(s) 114 to compare the initial allocation plan to the candidate allocation plans generated by the optimizer function(s) 112 to determine the differences between the initial allocation plan and the candidate allocation plans, which represent the proposed modification(s) to the initial allocation plan. The explanation function(s) 114 may generate a description of the proposed modification(s) to the initial allocation plan in natural language.

The method 400, at block B410, includes outputting a response to the user input indicative of the proposed modification(s) to the initial allocation plan. The planning function(s) 104 may assign task(s) for the explanation function(s) 114 to analyze the proposed modification(s) to the initial allocation plan and generate an analysis 115, which may include a summary, outline, key points, etc. in natural language (e.g., using LLM(s)). The analysis 115 may, for example, present the various proposed modification(s) to the initial allocation (e.g., explaining the specific changes for each of the candidate allocation plans) and an evaluation of the proposed modification(s) to the initial allocation plan (e.g., based on the rankings). The explanation function(s) 114 may provide the analysis 115 to the planning function(s) 104 to be output as the response to the user input.

In some embodiments, the agentic AI planner system 100 (e.g., the explanation function(s) 114) may generate and output report(s) (e.g., daily report(s)) or notification(s) with analysis different than that described above. For example, the agentic AI planner system 100 may generate report(s) or notification(s) based on current allocation plans and/or supply chain data from the data store(s) 122 to highlight products, customers, and/or allocations that may be high priority (e.g., needing attention). The high-priority items may be identified, at least in part, based on attention score(s) determined for the current allocation plans. The report(s) may also include (e.g., week-over-week) key figures related to supply and/or demand data and/or other insights that may be configurable by a user.

In some examples, the machine learning model(s) (e.g., deep neural networks, language models, LLMs, SLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein (e.g., used to implement the functions of the agentic AI planner system 100) may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), Gaussian splat techniques, diffusion models, transformer models, etc.), systems implemented at least partially in a data center, systems for performing conversational AI operations, systems implementing one or more language models-such as one or more large language models (LLMs), one or more small language models (SLMs), one or more vision language models (VLMs), one or more multi-modal language models (MMLMs), etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. In some embodiments, one or more functions of the agentic AI planner system 100 described herein may be implemented, at least in part, using language models. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which the LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models— or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g., updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 5A is a block diagram of an example generative language model system 500 suitable for use in implementing at least some embodiments of the present disclosure. In the example illustrated in FIG. 5A, the generative language model system 500 includes a retrieval augmented generation (RAG) component 592, an input processor 505, a tokenizer 510, an embedding component 520, plug-ins/APIs 595, and a generative language model (LM) 530 (which may include an LLM, a SLM, a VLM, a multi-modal LM, etc.). In some embodiments, one or more functions of the agentic AI planner system 100 described herein may be implemented using features similar to those of the generative language model system 500.

At a high level, the input processor 505 may receive an input 501 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 530 (e.g., LLM/SLM/VLM/MMLM/etc.). In some embodiments, the input 501 includes plain text in the form of one or more sentences, paragraphs, and/or documents. Additionally or alternatively, the input 501 may include numerical sequences, precomputed embeddings (e.g., word or sentence embeddings), and/or structured data (e.g., in tabular formats, JSON, or XML). In some implementations in which the generative LM 530 is capable of processing multi-modal inputs, the input 501 may combine text (or may omit text) with image data, audio data, video data, design data, USD data, and/or other types of input data, such as but not limited to those described herein. Taking raw input text as an example, the input processor 505 may prepare raw input text in various ways. For example, the input processor 505 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 505 may remove stopwords to reduce noise and focus the generative LM 530 on more meaningful content. The input processor 505 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 592 (which may include one or more RAG models, and/or may be performed using the generative LM 530 itself) may be used to retrieve additional information to be used as part of the input 501 or prompt. RAG may be used to enhance the input to the LLM/SLM/VLM/MMLM/etc. with external knowledge, so that answers to specific questions or queries or requests are more relevant-such as in a case where specific knowledge is required. The RAG component 592 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 501 may be generated using the query or input to the model (e.g., a question, a request, etc.) in addition to data retrieved using the RAG component 592. In some embodiments, the input processor 505 may analyze the input 501 and communicate with the RAG component 592 (or the RAG component 592 may be part of the input processor 505, in embodiments) in order to identify relevant text and/or other data to provide to the generative LM 530 as additional context or sources of information from which to identify the response, answer, or output 590, generally. For example, where the input indicates that the user is interested in a desired tire pressure for a particular make and model of vehicle, the RAG component 592 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 592 may retrieve a prior stored conversation history—or at least a summary thereof—and include the prior conversation history along with the current ask/request as part of the input 501 to the generative LM 530.

The RAG component 592 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 592 and the embeddings of the chunks along with the embeddings of the query may be compared to identify the most similar/related embeddings to the query, which may be supplied to the generative LM 530 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 592 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 510 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 530 to understand morphological variations and handle out-of-vocabulary words more effectively. Character-based tokenization represents each character as a separate token, enabling the generative LM 530 to process text at a fine-grained level. The choice of tokenization strategy may depend on factors such as the language being processed, the task at hand, and/or characteristics of the training dataset. As such, the tokenizer 510 may convert the (e.g., processed) text into a structured format according to tokenization schema being implemented in the particular embodiment.

The embedding component 520 may use any known embedding technique to transform discrete tokens into (e.g., dense, continuous vector) representations of semantic meaning. For example, the embedding component 520 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 501 includes image data/video data/etc., the input processor 505 may resize the data to a standard size compatible with format of a corresponding input channel and/or may normalize pixel values to a common range (e.g., 0 to 1) to ensure a consistent representation, and the embedding component 520 may encode the image data using any known technique (e.g., using one or more convolutional neural networks (CNNs) to extract visual features). In some implementations in which the input 501 includes audio data, the input processor 505 may resample an audio file to a consistent sampling rate for uniform processing, and the embedding component 520 may use any known technique to extract and encode audio features—such as in the form of a spectrogram (e.g., a mel-spectrogram). In some implementations in which the input 501 includes video data, the input processor 505 may extract frames or apply resizing to extracted frames, and the embedding component 520 may extract features such as optical flow embeddings or video embeddings and/or may encode temporal information or sequences of frames. In some implementations in which the input 501 includes multi-modal data, the embedding component 520 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 530 and/or other components of the generative LM system 500 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 520 may apply an encoded representation of the input 501 to the generative LM 530, and the generative LM 530 may process the encoded representation of the input 501 to generate an output 590, which may include responsive text and/or other types of data.

As described herein, in some embodiments, the generative LM 530 may be configured to access or use—or capable of accessing or using—plug-ins/APIs 595 (which may include one or more plug-ins, application programming interfaces (APIs), databases, data stores, repositories, etc.). For example, for certain tasks or operations that the generative LM 530 is not ideally suited for, the model may have instructions (e.g., as a result of training, and/or based on instructions in a given prompt, such as those retrieved using the RAG component 592) to access one or more plug-ins/APIs 595 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 595 to the plug-in/API 595, the plug-in/API 595 may process the information and return an answer to the generative LM 530, and the generative LM 530 may use the response to generate the output 590. This process may be repeated—e.g., recursively—for any number of iterations and using any number of plug-ins/APIs 595 until an output 590 that addresses each ask/question/request/process/operation/etc. from the input 501 can be generated. As such, the model(s) may not only rely on its own knowledge from training on a large dataset(s) and/or from data retrieved using the RAG component 592, but also on the expertise or optimized nature of one or more external resources—such as the plug-ins/APIs 595.

FIG. 5B is a block diagram of an example implementation in which the generative LM 530 includes a transformer encoder-decoder. For example, assume input text such as “Who discovered gravity” is tokenized (e.g., by the tokenizer 510 of FIG. 5A) into tokens such as words, and each token is encoded (e.g., by the embedding component 520 of FIG. 5A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 535 of the generative LM 530.

In an example implementation, the encoder(s) 535 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 540 may convert the context vector into attention vectors (keys and values) for the decoder(s) 545.

In an example implementation, the decoder(s) 545 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 535, in an example transformer architecture, each token (e.g., word) flows through a separate path in the decoder(s) 545. During a first pass, the decoder(s) 545, a classifier 550, and a generation mechanism 555 may generate a first token, and the generation mechanism 555 may apply the generated token as an input during a second pass. The process may repeat in a loop, successively generating and adding tokens (e.g., words) to the output from the preceding pass and applying the token embeddings of the composite sequence with positional encodings as an input to the decoder(s) 545 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 535, except that it creates its queries from the layer below it and takes the keys and values (e.g., matrix) from the output of the encoder(s) 535.

As such, the decoder(s) 545 may output some decoded (e.g., vector) representation of the input being applied during a particular pass. The classifier 550 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 555 may select or sample a word or token based on a corresponding predicted probability (e.g., select the word with the highest predicted probability) and append it to the output from a previous pass, generating each word or token sequentially. The generation mechanism 555 may repeat the process, triggering successive decoder inputs and corresponding predictions until selecting or sampling a symbol or token that represents the end of the response, at which point, the generation mechanism 555 may output the generated response.

FIG. 5C is a block diagram of an example implementation in which the generative LM 530 includes a decoder-only transformer architecture. For example, the decoder(s) 560 of FIG. 5C may operate similarly as the decoder(s) 545 of FIG. 5B except each of the decoder(s) 560 of FIG. 5C omits the encoder-decoder self-attention layer (since there is no encoder in this implementation). As such, the decoder(s) 560 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 560. As with the decoder(s) 545 of FIG. 5B, each token (e.g., word) may flow through a separate path in the decoder(s) 560, and the decoder(s) 560, a classifier 565, and a generation mechanism 570 may use auto-regression to sequentially generate one token at a time until predicting a symbol or token that represents the end of the response. The classifier 565 and the generation mechanism 570 may operate similarly as the classifier 550 and the generation mechanism 555 of FIG. 5B, with the generation mechanism 570 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 6 is a block diagram of an example computing device(s) 600 suitable for use in implementing some embodiments of the present disclosure. In some embodiments, one or more functions of the agentic AI planner system 100 described herein may be implemented, at least in part, using the computing device 600. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs. In some embodiments, one or more functions of the agentic AI planner system 100 described herein may be executed, at least in part, by the CPU(s) 606 and/or GPU(s) 608.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608. In some embodiments, one or more functions of the agentic AI planner system 100 described herein may be executed, at least in part, by the logic unit(s) 620.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-716(N) may include one or more virtual components, such as vGPUs, vCPUs, and/or the like, and/or one or more of the node C.R.s 716(1)-716(N) may correspond to a virtual machine (VM). In some embodiments, one or more functions of the agentic AI planner system 100 described herein may be implemented, at least in part, using one or more of the node C.R.s 716(1)-716(N).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may use distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
receive a user input comprising one or more modifications to a first allocation plan;
determine a category of the user input based at least on content of the user input;
retrieve a dataset from one or more data stores that is relevant to the category of the user input and the one or more modifications to the first allocation plan;
modify the dataset retrieved from the one or more data stores to generate one or more models based at least on the category of the user input and the one or more modifications to the first allocation plan, wherein the one or more models define one or more variables, one or more constraints, and one or more objectives;
generate an updated allocation plan based at least on values for the one or more variables determined using an optimization process based at least on the one or more models; and
output a response to the user input indicative of the updated allocation plan.

2. The one or more processors of claim 1, wherein the processing circuitry is to generate one or more tasks to be executed by one or more machine learning models based at least on the category of the user input and the one or more modifications to the first allocation plan.

3. The one or more processors of claim 2, wherein the processing circuitry is further to:
generate code during execution of at least one task of the one or more tasks;
execute the code in place to determine whether the code includes one or more errors; and
in response to a determination that the code includes one or more errors, generate revised code based at least on the one or more errors, the code, and task content for the at least one task of the one or more tasks.

4. The one or more processors of claim 1, wherein the optimization process comprises at least one of linear programming or mixed-integer linear programming.

5. The one or more processors of claim 1, wherein the processing circuitry is further to:
receive a second user input comprising a request to suggest modifications to a second allocation plan;
determine a category of the second user input based at least on content of the second user input;
execute simulations for candidate allocation plans with different parameters based on the category of the second user input and the content of the second user input; and
generate one or more proposed modifications to the second allocation plan based at least on one or more evaluation metrics for the candidate allocation plans.

6. The one or more processors of claim 1, wherein the processing circuitry is further to:
determine one or more attention values for products in the first allocation plan or the updated allocation plan based at least on a time-discounted supply-demand gap or a time-discounted allocation-demand gap for the products; and
generate a notification identifying one or more of the products in the first allocation plan or the updated allocation plan as needing attention based at least on the one or more attention values for the products.

7. The one or more processors of claim 1, wherein the user input comprises one or more prompts generated from one or more selections of predetermined options for the one or more modifications to the first allocation plan.

8. The one or more processors of claim 1, wherein the processing circuitry is further to:
compare the first allocation plan to the updated allocation plan to determine one or more differences between the first allocation plan and the updated allocation plan; and
generate an indication of the one or more differences between the first allocation plan and the updated allocation plan, wherein the response to the user input indicative of the updated allocation plan comprises the indication of the one or more differences between the first allocation plan and the updated allocation plan.

9. The one or more processors of claim 1, wherein the processing circuitry is further to:
generate one or more logs of operations performed during execution of one or more tasks by one or more machine learning models;
receive feedback indicative of a quality of at least one of the updated allocation plan or analysis of the updated allocation plan; and
update one or more parameters of the one or more machine learning models based at least on one or more of the one or more logs or the feedback.

10. The one or more processors of claim 1, wherein the processing circuitry is further to generate a summary of the updated allocation plan using one or more machine learning models, wherein the response to the user input indicative of the updated allocation plan comprises the generated summary.

11. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more small language models (SLMs);
a system implementing one or more vision language models (VLMs);
a system implementing one or more multi-modal language models (MMLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

12. A system comprising one or more processors to:
determine a category of a user input received via a user interface based at least on content of the user input, wherein the content of the user input comprises data related to one or more modifications to a first allocation plan;
generate one or more tasks to be performed based at least on the category of the user input and the content of the user input; and
execute the one or more tasks, wherein execution of the one or more tasks includes:
generating one or more models based at least on data retrieved from one or more data stores that is relevant to the content of the user input, wherein the one or more models define one or more variables, one or more constraints, and one or more objectives;
generating one or more updated allocation plans based at least on values for the one or more variables determined using an optimization process based at least on the one or more models; and
outputting a response to the user input indicative of the one or more updated allocation plans.

13. The system of claim 12, wherein the one or more processors are further to:
generate one or more logs of operations performed during execution of the one or more tasks;
receive feedback indicative of a quality of at least one of the one or more updated allocation plans or analysis of the one or more updated allocation plans; and
update one or more parameters of one or more machine learning models based at least on one or more of the one or more logs or the feedback.

14. The system of claim 12, wherein the one or more processors are further to generate an indication of differences between the first allocation plan and the one or more updated allocation plans, wherein the response to the user input indicative of the one or more updated allocation plans comprises the indication of differences between the first allocation plan and the one or more updated allocation plans.

15. The system of claim 12, wherein the one or more processors are further to:
determine one or more attention values for products in the first allocation plan or the one or more updated allocation plans based at least on a time-discounted supply-demand gap or a time-discounted allocation-demand gap for the products; and
generate a notification identifying one or more of the products in the first allocation plan or the one or more updated allocation plans as needing attention based at least on the one or more attention values.

16. The system of claim 12, wherein the one or more processors are further to:
execute simulations for candidate allocation plans with different parameters in response to a second user input received via the user interface, wherein the second user input includes a request for proposed modifications to the first allocation plan;
generate one or more evaluation metrics for the candidate allocation plans; and
generate one or more proposed modifications to the first allocation plan based at least on the one or more evaluation metrics for the candidate allocation plans.

17. The system of claim 16, wherein the one or more evaluation metrics comprise one or more attention values for products in the candidate allocation plans, wherein the one or more attention values are generated based at least on a time-discounted supply-demand gap or a time-discounted allocation-demand gap for the products.

18. The system of claim 12, wherein the one or more processors are to:
generate code during execution of at least one task of the one or more tasks;
execute the code in place to determine whether the code includes one or more errors; and
in response to a determination that the code includes one or more errors, generate revised code based at least on the one or more errors, the code, and task content for the at least one task of the one or more tasks.

19. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more small language models (SLMs);
a system implementing one or more vision language models (VLMs);
a system implementing one or more multi-modal language models (MMLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

20. A method comprising:
generating one or more updated allocation plans based at least on one or more variables using an optimization process for one or more models, wherein the one or more models are generated based at least on a determined category of a user input including data indicative of one or more modifications to an initial allocation plan and one or more datasets retrieved from one or more data stores that are relevant to the data indicative of one or more modifications to the initial allocation plan.
